(19) United States
(12) Patent Application Publication
(10) Pub. No.: US 2003/0158745 A1
(43) Pub. Date: Aug. 21, 2003

(54) System and method of documenting, tracking and facilitating the development of intellectual property

(76) Inventors: David Katz, Greenwich, CT (US); Rush McCloy, Greenwich, CT (US)

Correspondence Address: DICKSTEIN SHAPIRO MORIN & OSHINSKY LLP, 2101 L STREET NW, WASHINGTON, DC, 20037-1526, US

(21) Appl. No.: 10/233,596

(22) Filed: Sep. 4, 2002

Related U.S. Application Data
(60) Provisional application No. 60/316,299, filed on Sep. 4, 2001.

(51) Int. Cl. G06F 17/60

(52) U.S. Cl. 705/1; 705/35

(57) ABSTRACT

A system and method is provided that allows a company to maintain a dynamic network database of intellectual capital. Entries in the database are stored on individual computers. Searches are conducted by transmitting a search request to each computer on the network. In addition, companies can post intellectual capital for other companies to view and to search. The system also facilitates the development of intellectual capital when the members of the development team are not in the same location by providing methods of communication, scheduling, sharing files and searching for additional team members.

### FIELD OF THE INVENTION

The present invention relates to the management of intellectual capital and more particularly to a system and method for a company to internally keep track of intellectual capital and to allow other companies to access information about intellectual capital available for licensing or purchase.

### BACKGROUND OF THE INVENTION

A corporation's ability to capitalize on its assets both internally and externally directly affects profits. Companies face a variety of challenges in maximizing the uses of their portfolios. First, many companies have difficulty keeping their employees informed about intellectual capital. Developers, managers, executives and attorneys are often on disparate internal networks, which creates problems for employees to know what the company's intellectual capital consists of Second, there are similarly many people within these companies who could use its intellectual capital, but are not aware of it. As a result, these companies are not making full use of their intellectual capital portfolios.

Third, companies do not have a simple and convenient way to license patents. Companies with extensive patent portfolios will often grant blanket licenses to their portfolios to simplify the transaction. Fourth, smaller companies don't have an easy time soliciting licensees.

Therefore, there exists a need in the art for a method and apparatus that provides individuals and companies with a way to keep other employees informed about the company's intellectual capital and provides individuals with access to said information. There is also a need in the art for a method and apparatus that provides individuals and companies with a way to efficiently and effectively develop and market intellectual capital.

### BRIEF SUMMARY OF THE INVENTION

Briefly, the present invention enables a company to maintain a dynamic network database of intellectual capital. The system stores each entry in a database on a computer that it is entered on. Upon a search request the system transmits keywords to every computer on the network. The system transmits back any matching entries to the querying computer. Each user has an assigned access level and can only view entries at or below his or her assigned level. Entries also have two access levels—one for viewing an abstract and another for viewing the whole entry.

Another aspect of the present invention involves providing companies with a method of posting intellectual capital for other companies to view and to search. Each company can post an entry, or an abstract of an entry, to a listing computer. Each company can then search the listing computer for entries that match search criteria. When a matching entry is selected, either the full entry is displayed or contact information for the appropriate person to contact to obtain more information is displayed.

In addition, the present invention provides a system and method for facilitating the development of intellectual capital when the members of the development team are not in the same location. Methods of communication, scheduling, sharing files and searching for additional team members are described.

### BRIEF DESCRIPTION OF THE DRAWINGS

The above and other features and advantages of the invention will be more readily understood from the following detailed description of the invention, which is provided in connection with the accompanying drawings.

FIG. 1 is a block diagram of an exemplary embodiment of a system for performing a method of documenting, tracking and developing intellectual property in accordance with the present invention;

FIG. 2 is a block diagram of a PC used in an exemplary embodiment of the system shown in FIG. 1;

FIG. 3 is an organizational chart for the main page of the system shown in FIG. 1 in accordance with a preferred embodiment of the invention;

FIG. 4 is a screenshot of the main page of shown in FIG. 3 in accordance with a preferred embodiment of the invention;

FIG. 5 is an organizational chart for a new innovations page of the system and accessible through the main page as shown in FIG. 3, in accordance with a preferred embodiment of the invention;

FIG. 6 is an organizational chart of an innovations page of the system and accessible through the main page as shown in FIG. 3, in accordance with a preferred embodiment of the invention;

FIG. 7 is a screenshot of a WorkTracker feature of the system in accordance with a preferred embodiment of the invention;

FIG. 8 is a screenshot of an exemplary innovation abstract which can be stored and accessed in the system and according to the method of the present invention;

FIG. 9 is a screenshot of an exemplary strategy abstract which can be stored and accessed in the system and according to the method of the present invention;

FIG. 10 is a screenshot of an exemplary financial abstract which can be stored and accessed in the system and according to the method of the present invention;

FIG. 11 is a screenshot of an exemplary legal abstract which can be stored and accessed in the system and according to the method of the present invention;

FIG. 12 is an organizational chart of an innovation query page accessible through the main page of the system as shown in FIG. 3, in accordance with a preferred embodiment of the present invention;

FIG. 13 is a screenshot of an exemplary innovation query page shown in FIG. 12 in accordance with a preferred embodiment of the present invention;

FIG. 14 is a flowchart illustrating an example of a query for locating information regarding innovations matching specified search criteria and performed using the system in accordance with the method of the present invention.

FIG. 15 is a screenshot of an exemplary innovation query results page obtained upon execution of an innovation query in accordance with a preferred embodiment of the present invention;

FIG. 16 is an organizational chart of a PeerNet feature accessible through the main page of the system as shown in FIG. 3, in accordance with a preferred embodiment of the present invention;

FIG. 17 is a screenshot of an exemplary “find peers” function of the PeerNet feature shown in FIG. 16 in accordance with a preferred embodiment of the present invention;

FIG. 18 is a screenshot of an exemplary “ask peers” function of the PeerNet feature shown in FIG. 16 in accordance with a preferred embodiment of the present invention;

FIG. 19 is an organizational chart of a shared workspace accessible through the main page of the system as shown in FIG. 3, in accordance with a preferred embodiment of the present invention;

FIG. 20 is a screenshot of an exemplary documents page of the shared workspace shown in FIG. 19 in accordance with a preferred embodiment of the present invention;

FIG. 21 is a screenshot of an exemplary task list of the shared workspace shown in FIG. 19 in accordance with a preferred embodiment of the present invention;

FIG. 22 is a screenshot of a second exemplary task list of the shared workspace in accordance with the present invention;

FIG. 23 is a screenshot of a ThoughtBox feature of the system as shown in FIG. 1, in accordance with a preferred embodiment of the present invention;

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention. It is to be understood that structural changes may be made and equivalent structures substituted for those shown without departing from the spirit and scope of the present invention.

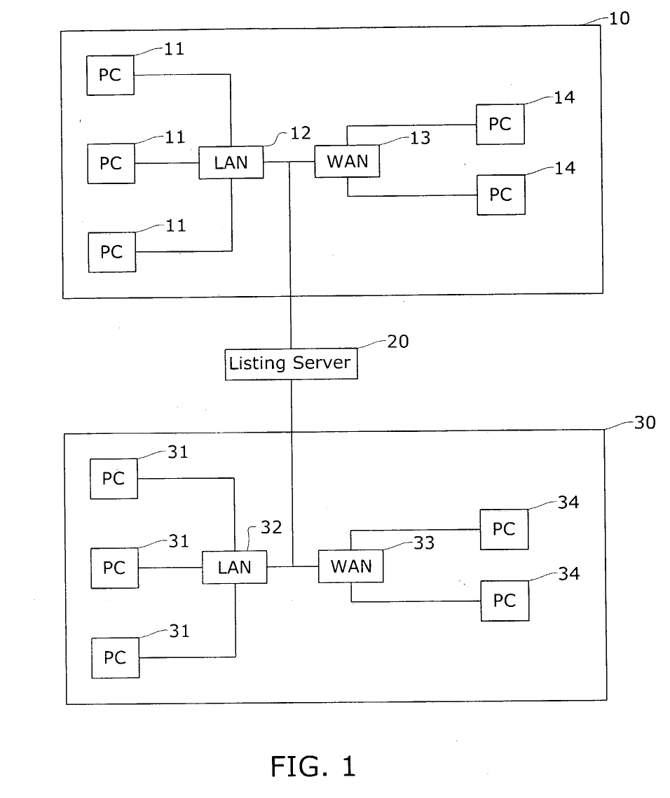

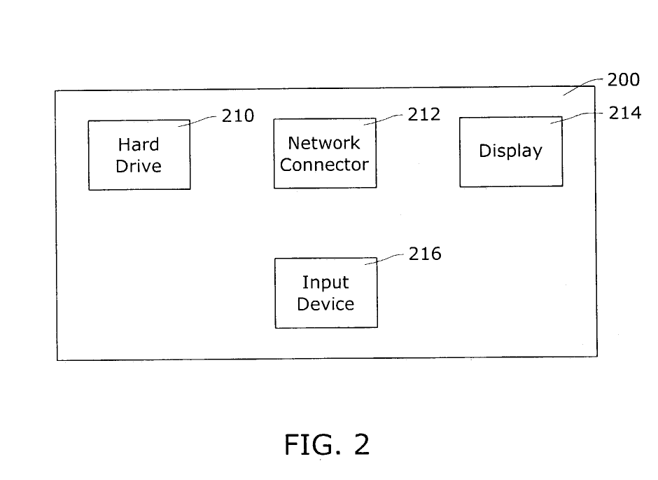

In a preferred embodiment of the present invention, as shown in FIG. 1, a user interface links desktop personal computers (PC's) 11, 14, 31, and 34 in a dynamic network 10. It is anticipated that each PC can comprise standard personal computer hardware. Any form of known computer can be substituted, however, including laptop computers, servers, PDA's or other logic devices capable of data entry and storage. The network 10 allows access to a database of information where the various entries in the database are respectively stored on the PC's 11, 14, 31, or 34 of the user who entered the information. Each PC, shown in more detail in FIG. 2 as PC 200, requires a hard drive 210 to store data, a network connector 212 to transmit and receive data from other PCs, a display 214 for the user to view the user interface on and an input device 216 for the user to enter data and manipulate information. The network connector 212 can be an ethernet card connected to the network or a modem that connects over a phone line, cable line, DSL line or via satellite. The input device 216 can be a keyboard and/or mouse.

There are various levels of access that determine how much of each entry can be viewed. The lowest level of access enables users to view innovation abstracts. A highest level of access allows viewing of entire patents, patent applications, trade secret information, development notes and documents prepared during the development of an innovation. Various in-between levels of access enable the viewing of successively larger portions of the intellectual assets stored in the database.

Returning to FIG. 1, the PC 11, for example, can access another PC 11 over a LAN 12 or a PC 14 over a WAN. This architecture allows engineers to easily collaborate from different locations. This architecture also avoids the pitfalls associated with information-isolation, such as performing wasteful duplicate research. Managers can now more easily track aspects of the company's intellectual capital portfolio; and marketing representatives, executives and attorneys can view both what products a company currently has protected as well as what coverage the company has for its research.

In addition to providing internal access to information about intellectual capital, the present invention also allows a company to display information regarding its intellectual capital to outside entities. By displaying information regarding intellectual capital, a company will be able to leverage its intellectual capital more efficiently. However, since no company wants to compromise network security by granting access to its network to outside entities for the purposes of searching, PCs 11 or 14 can access PCs 31 or 34 through a listing server 20.

A database of abstracts is maintained on listing server 20 for storing abstracts released by each participating company for any intellectual capital that it wants to license out to others. Each participating company can also search the database on the listing server to identify any intellectual property that it may want,to license from other intellectual property owners. If a company finds the abstract of something it wants to take a license from another owner, it can retrieve contact information for the appropriate employee of the company that posted the abstract.

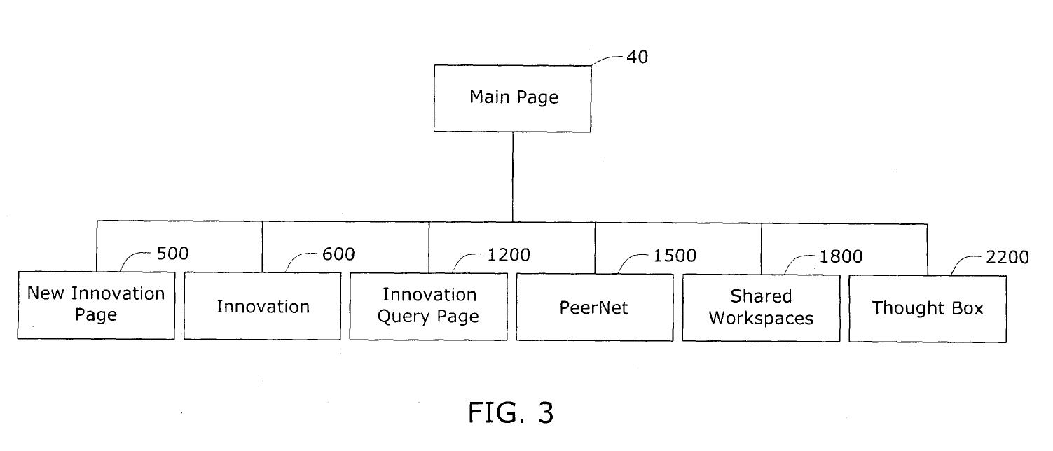

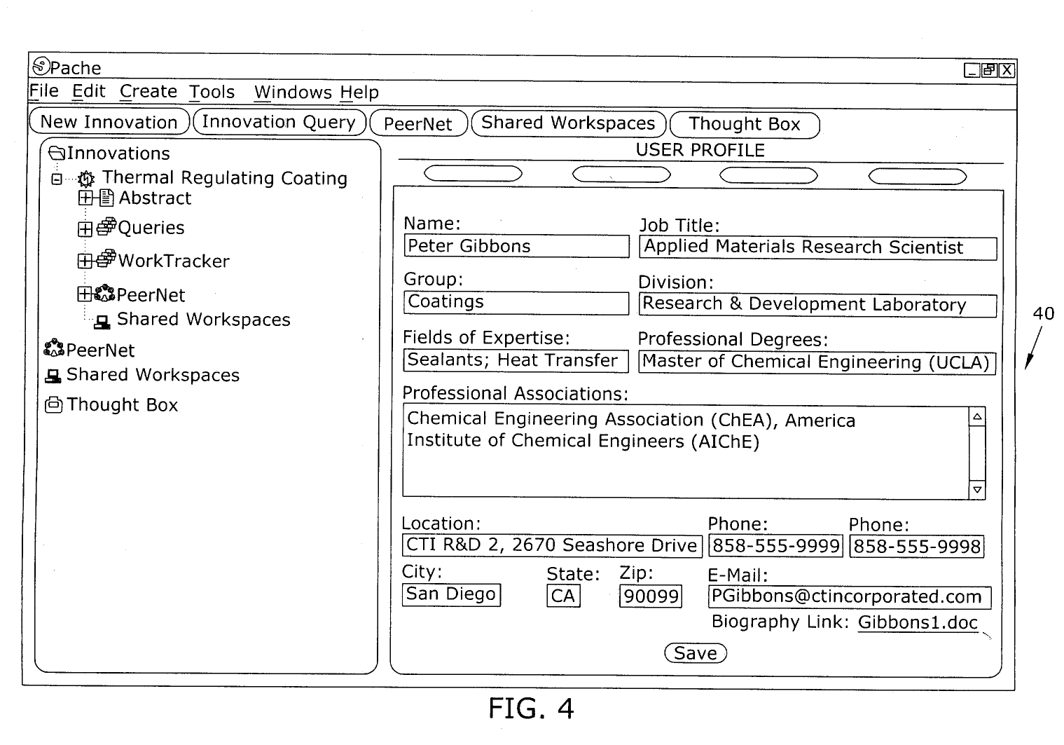

When a user accesses the system, the main page 40, as exemplified in FIGS. 3 and 4, is displayed. The first time a user accesses the main page 40, basic information such as the user's name, job title, group, division, fields of expertise, professional degrees, professional associations, location, phone number, fax number and e-mail address, as shown in FIG. 4, is entered into the appropriate fields. Some of this information is automatically retrieved from existing employee databases. Any information that can not be found in the existing employee databases is left blank for the user to enter. Each subsequent time the user accesses the main page 40, this basic information is displayed so that if any information has changed, it can be updated in the database. Additional information such as the user's level of access is controlled by a network administrator responsible for maintaining the security of the system.

In addition to the user's basic information, the main page 40 provides links to a new inovation page 500, an innovations folder 600, an innovation query page 1200, a PeerNet 1500, a shared workspace 1800 and a ThoughtBox 2200.

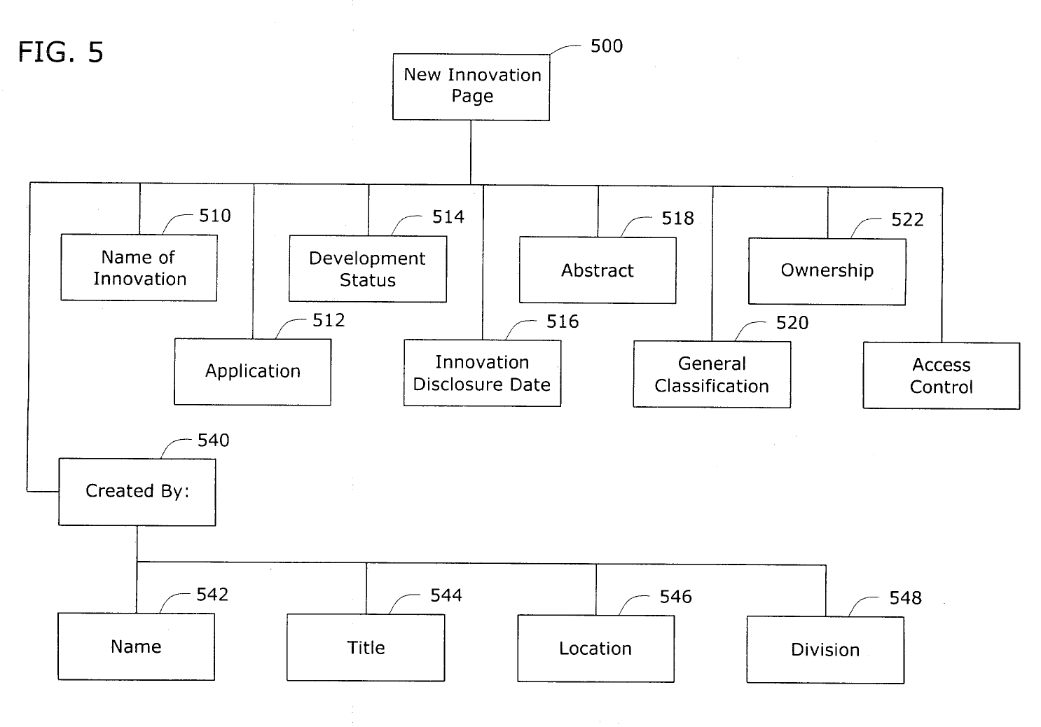

When a user wants to enter information regarding a new innovation into the database, the user selects the new innovation tab 500 from the main page. The new innovation page, as depicted in FIG. 5, allows the user to enter the name of the innovation 510, the applications for the innovation 512, the development status 514, the innovation disclosure date 516, the abstract 518, the general classification 520, the ownership 522, the access control 524 and who the innovation was created by 540. This last field is broken down into personnel data such as the innovator's name 542, title 544, location 546 and division 548.

The general classification field 520 is a top-level user-defined category to facilitate searching. The access control 524 allows the user to identify: (i) the specific business units that can access the abstract and (ii) a password necessary for viewing. The ownership 522 specifies which business unit owns the innovation.

While the user can enter all of this information, some or most of it may not be available at the time of creating a new innovation. As a result, not all of this information is necessary to start a new innovation folder. The current information for the user entering the new innovation data is automatically entered as the information for the creator of the innovation. However, the user can change this information if it is appropriate.

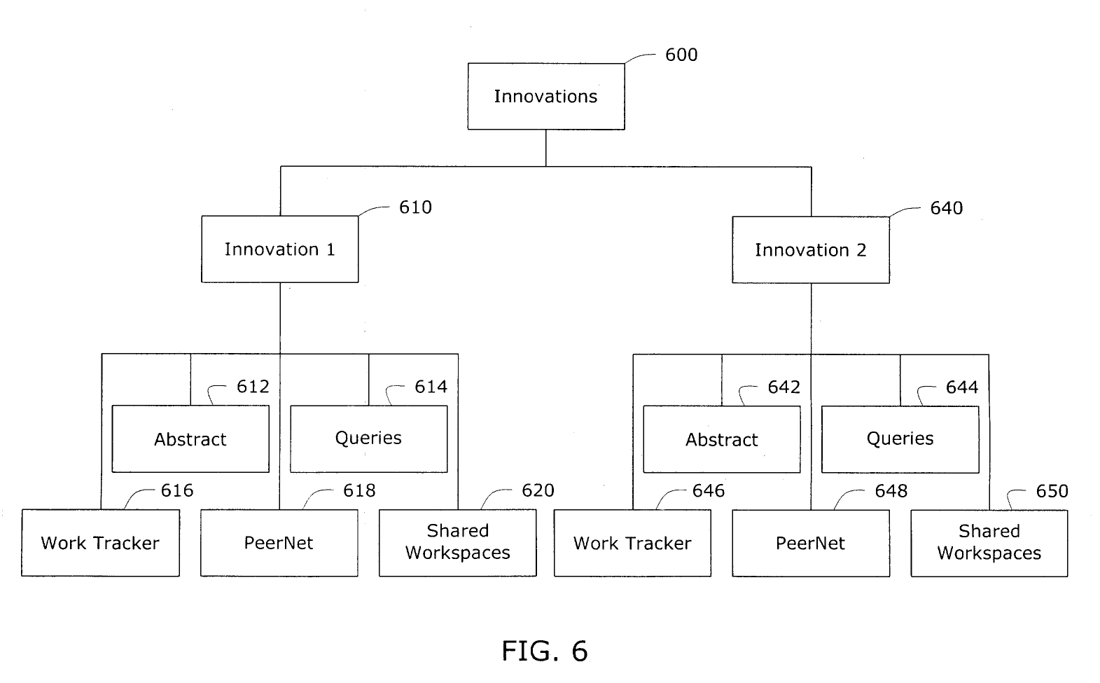

Each user can be working on multiple innovations 610 and 640 at the same time. Accordingly, innovations folder 600, depicted in FIG. 6, contains one entry for each innovation the user is working on, and can be accessed from every web page in the user interface. Each innovation that a user is working on is stored as a subfolder in the innovations folder 600. For example, the subfolder for “Innovation 1”, 610, would contain Innovation 1's abstract set 612, any related queries 614, a WorkTracker directory 616, a PeerNet access link 618 and a shared workspace access link 620.

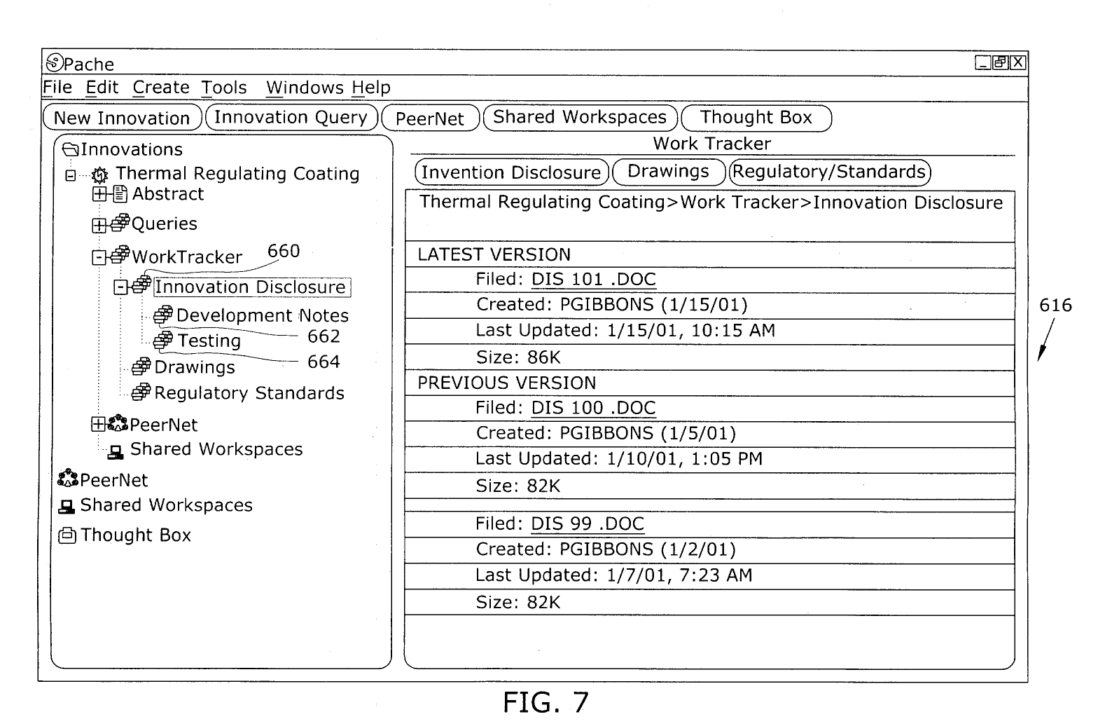

The WorkTracker directory 616, as illustrated in FIG. 7, contains, at a minimum, the latest version of the innovation disclosure (written description) stored in an innovation disclosure folder 660, the drawings stored in drawings folder 662 and any regulatory standards pertaining to the innovation stored in a regulatory standards folder 664. In addition, previous versions of each of these documents are saved. This allows the creator to store and organize all information related to the innovation in one location. Also, subfolders can be added to the innovation disclosure folder 660, the drawings folder 662 or the regulatory standards folder 664 to provide greater detail on the project.

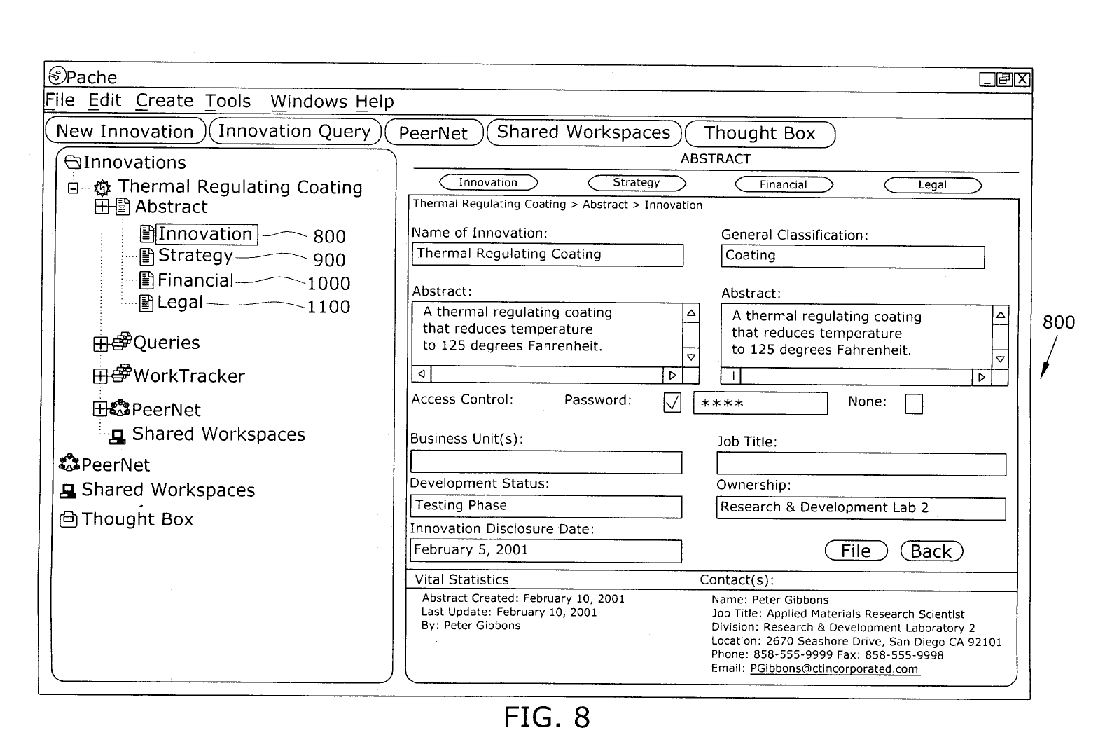

The abstract set 612 contains 4 files, as shown, for example, at the left side of FIG. 8. Specifically, the abstract set 612 includes an innovation abstract 800, a strategy abstract 900, a financial abstract 1000 and a legal abstract 1100. The innovation abstract 800, an example of which is shown in FIG. 8, contains basic scientific and/or technical information about the innovation that other members of the company can search over a LAN 12 or WAN 13. This information includes the name of the innovation, the general classification, an abstract, applications, access control, the business unit and job title of the inventor, the development status, ownership and innovation disclosure date. In addition, if authorized by the company, the information can be released to the listing server 20 so that other companies can search it. If a password is entered into the access control, access to any information not contained in the abstract will require receiving permission from the document's creator or project leader.

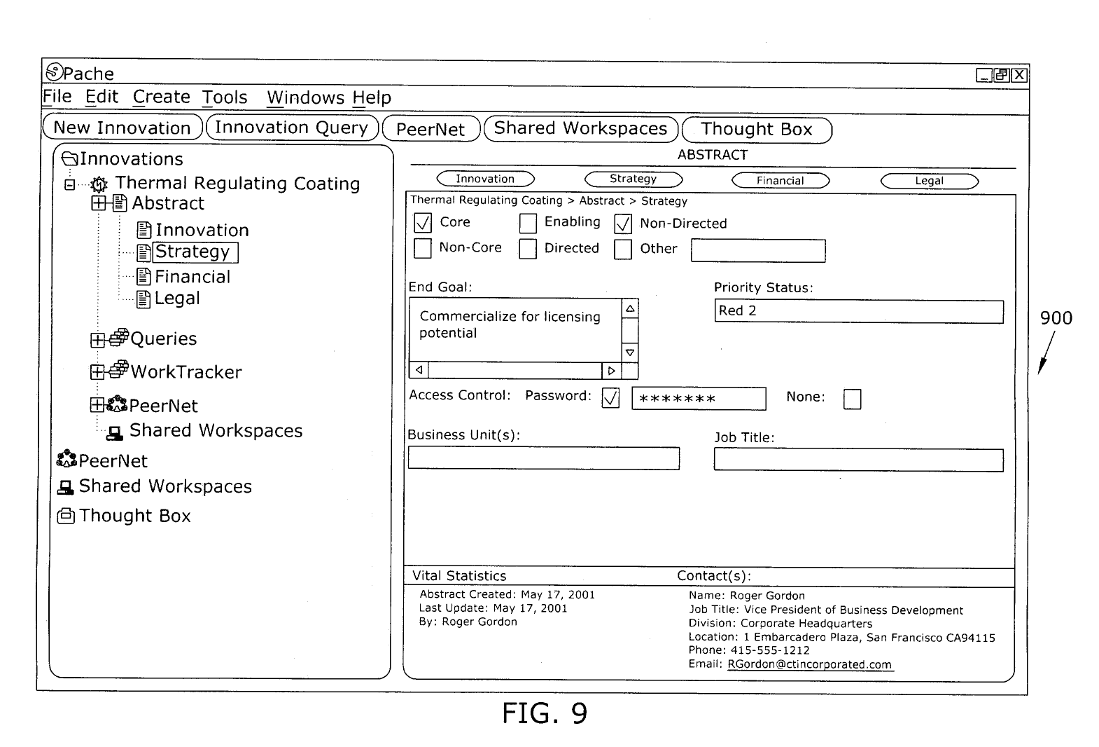

The second file in the abstract set 612 is the strategy abstract 900. The strategic abstract 900, an example of which is shown in FIG. 9, contains a strategic description of the innovation, an end-goal for the innovation, a priority status for completion, access control and contact information for the innovation. The strategy abstract 900 allows the company to identify the innovation's directive and priority.

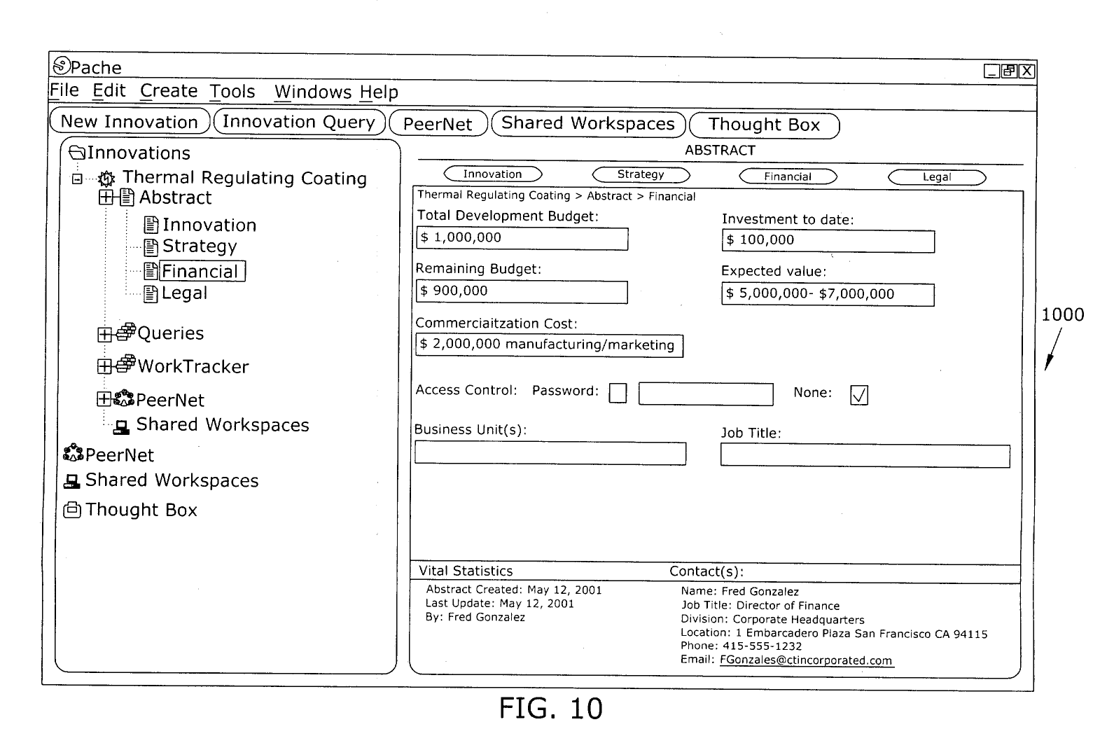

The third file in the abstract set 612 is the financial abstract 1000. The financial abstract 1000, an example of which is shown in FIG. 10, contains information on the financial status of the innovation, and allows financial professionals to include relevant information, such as: total development budget, investment to date, the remaining budget, the expected value, the expected cost of commercialization and access control.

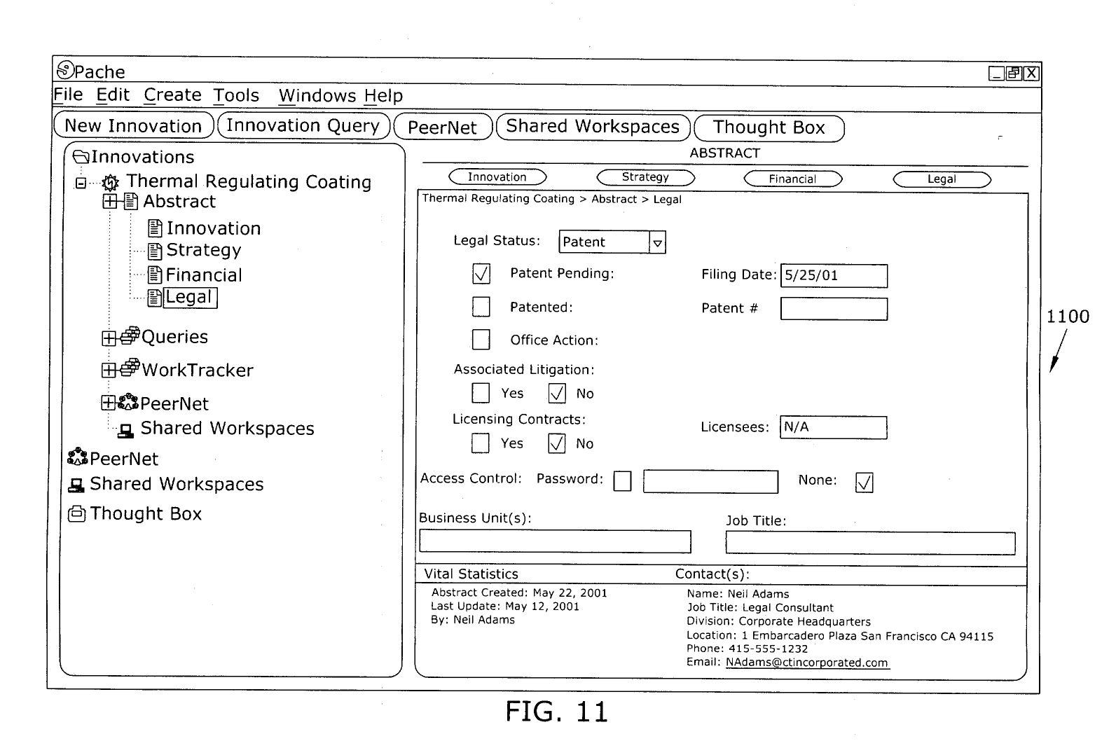

The fourth file in the abstract set 612 is the legal abstract 1100. The legal abstract 1100, an example of which is shown in FIG. 11, allows the company's attorneys to enter information regarding any patent applications or patents for the innovation so that executives can view the information at a glance.

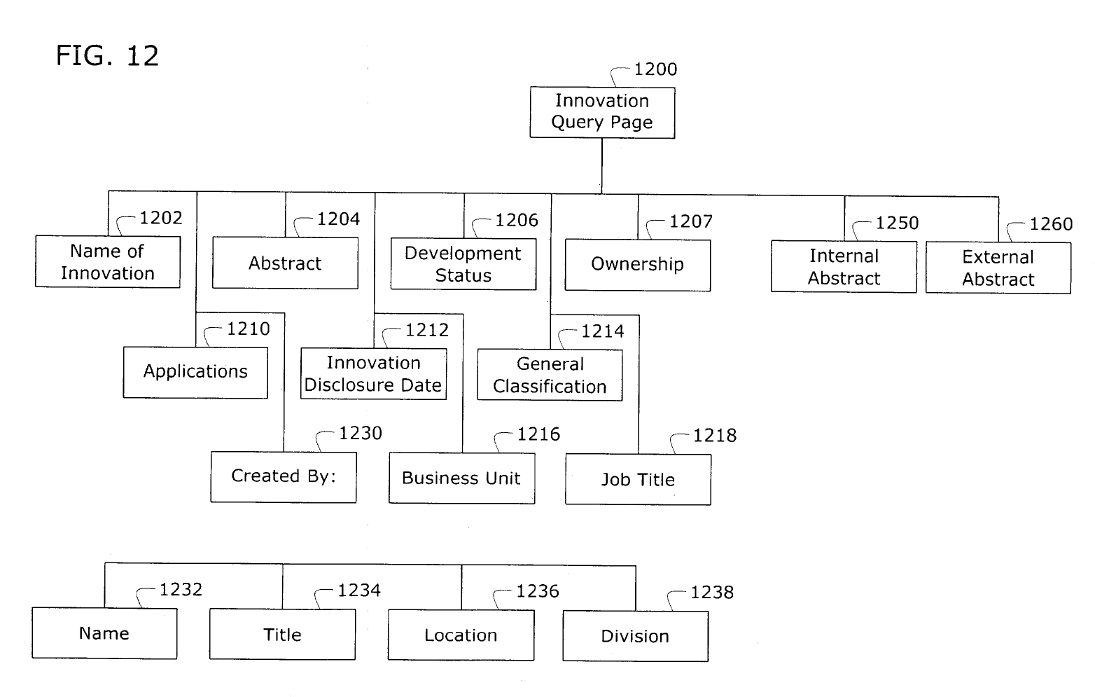

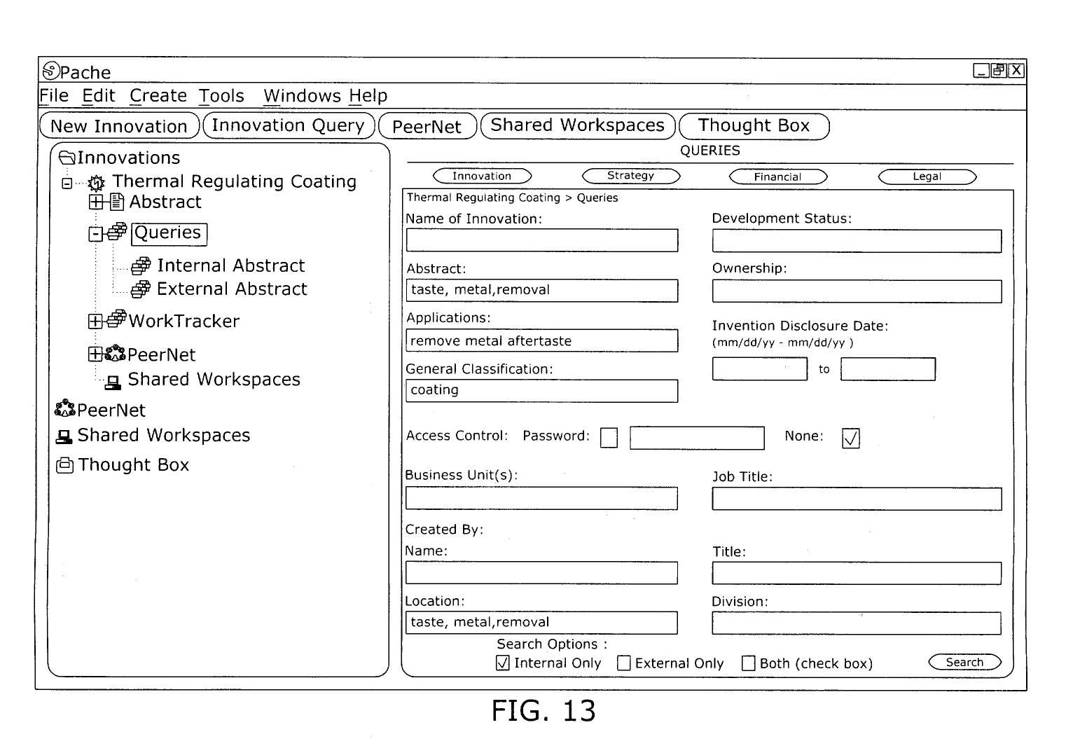

Each innovation subfolder 610 (FIG. 6) also contains a queries subfolder 614. The queries subfolder 614 keeps a record of all of the user's queries relating to the innovation. When a user selects the queries subfolder, a list of queries that the user has executed from this innovation folder are listed. The user can also select to run a new query which will take the user to the innovation query page 1200, such as that shown in FIGS. 12 and 13.

In addition, a user can access the innovation query page 1200 directly from the main page 40 or any other tab in the user interface, as can be seen in FIG. 3. The innovation query page 1200 allows the user to search either internal abstracts, external abstracts or both. These abstracts can be searched by many different criteria including the name of the innovation 1202, the abstract 1204, the development status 1206, the ownership of the innovation 1208, the applications 1210, the innovation disclosure date 1212, the general classification 1214, the business unit 1218, the job title 1220 or the creation information 1230 (name 1232, title 1234, location 1236 and division 1238). The abstracts can also be searched by any combination of these criteria.

When a search of the internal abstracts takes place, the user's PC 11, for example, submits a query that is transmitted to all other PCs 11 and 14 that are within the company. This includes both PCs 11 connected to the user's PC 11 over a LAN and PCs 14 connected to the user's PC 11 over a WAN. Any PCs containing matching abstracts that the user has access to then transmits a response with the relevant information. When a search of the external abstracts takes place, the user's PC 11 submits a query to the listing server 20. The listing server searches for any matching abstracts that are designated as public and transmits a response with those abstracts.

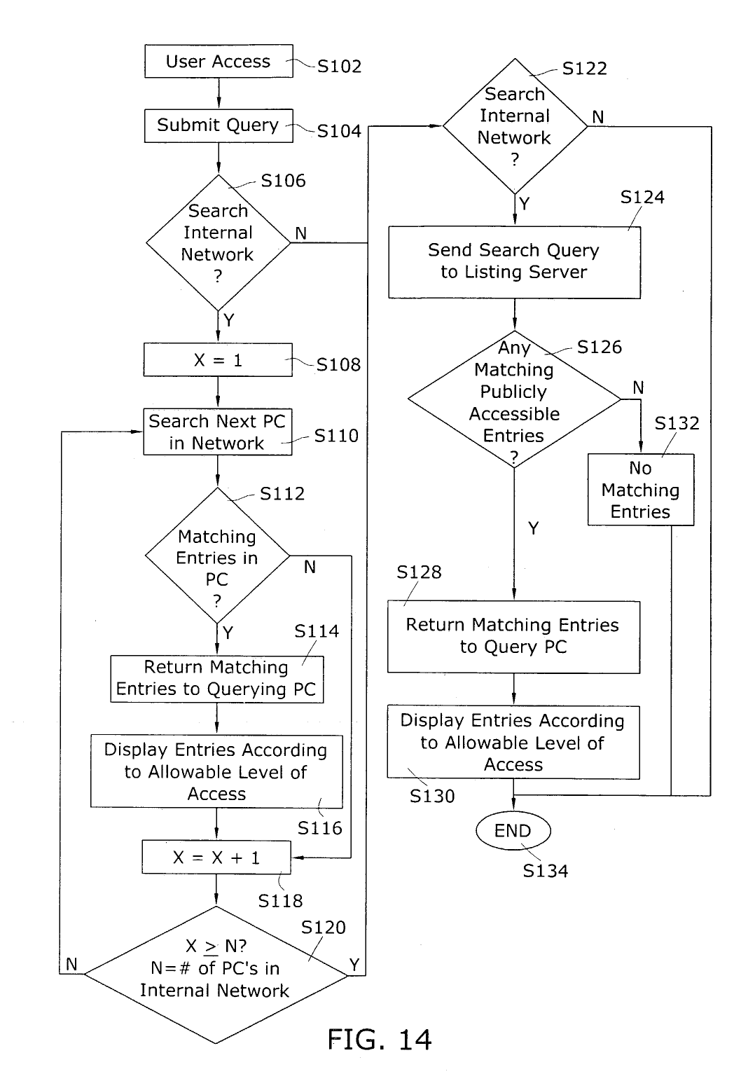

An exemplary method for executing a query from a PC 11, for example, is illustrated in FIG. 14 in accordance with present invention. In particular, after a user has accessed the system at step S102, the user submits a query using innovation query page 1200 at step S104. At step 106, the system determines whether the user has indicated to search the internal network. If not, the query method proceeds to step S122, which will be described further below.

If a search of the internal network is designated, in order to ensure that all the PCs in the system are queried, the system designates a first PC in the internal network to be searched at step S108, and then searches all of the innovation entries stored in that computer, at step S110 to determine if any of those entries match the search criteria entered in the query. If any matching entries are found (S112), the matching entries are returned to the querying PC 11 at step S114, and the entry information is displayed according to the level of access assigned to the user submitting the query (S116).

After execution of step S116, and also if no matching entries are found in the PC just searched, the process proceeds to step S118, where the system keeps track of which PCs have already been searched. If not all the PCs in the internal network have been searched (S120), the process returns to search the next PC in the network.

After all the PCs in the internal network have been searched, and also if the query does not designate a search of the internal network, the process proceeds to step S122, in which the system determines whether or not a search of the external network is desired. If not, the process is ended at step S134. If, on the other hand, an external search has been designated, the system sends the query to listing server 20, at step S124, to determine whether any innovation entries designated for public access and viewing match the search criteria of the query (S126). If not, the system returns a response to the querying PC 11 that no matching external entries were found (S132), and the process is ended at step S134.

As is the case with matching entries found in the internal network 10, if matching entries are found on the listing server 20, the system returns the matching entries to the querying PC 11 at step S128, whereupon the querying PC displays the matching entries according to the level of access allowed by the external entries and according to the user's assigned access level. The process is then ended at step S134.

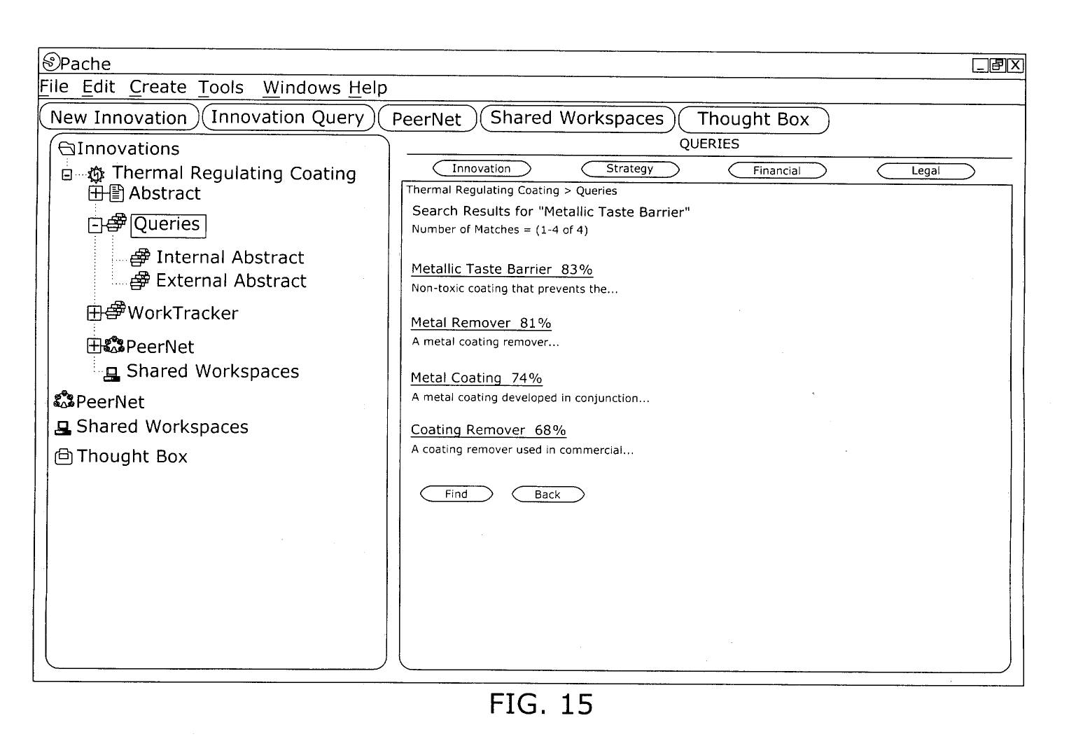

Once the user's PC 11 receives the results, the matching abstracts are listed, as shown in FIG. 15. The matching entries are listed in order of relevance to the search terms. The user can then select a matching entry and view the information. If the selected entry is an internal entry, the user can contact the inventor for further information. The internal entries can also be saved in the internal abstracts folder 1250 (FIG. 12) for future reference by the user or another user with access to the selected innovation. If the selected entry is an external entry, contact information for the other company is displayed. Similarly, the external abstract can be saved in an external abstracts folder 1260 (FIG. 12) for future reference by the user or another user with access to the selected innovation.

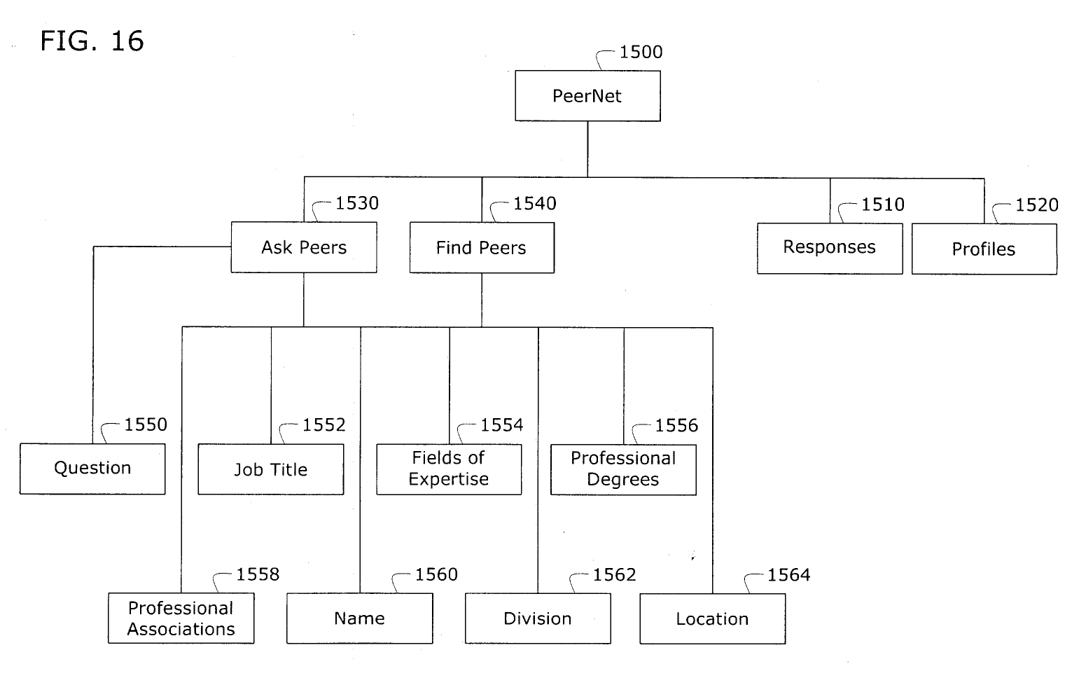

In addition to an abstract set 612 and a queries subfolder 614, each innovation subfolder 610 shown in FIG. 6 contains a PeerNet access link 618. The PeerNet is a data repository that allows users to locate, store and categorize electronic profiles of professionals with desired expertise related to a particular innovation. The profiled professionals can be the user's peers from within the user's company or in other companies 30 connected to the listing server 20 (FIG. 1). The PeerNet access link 618 allows the user to access the PeerNet 1500 feature of the present invention, the organization of which is illustrated in FIG. 16. Like the innovation query page 1200, the PeerNet 1500 can be accessed both from within an innovation subfolder or directly from the main page 40, independently of any innovations.

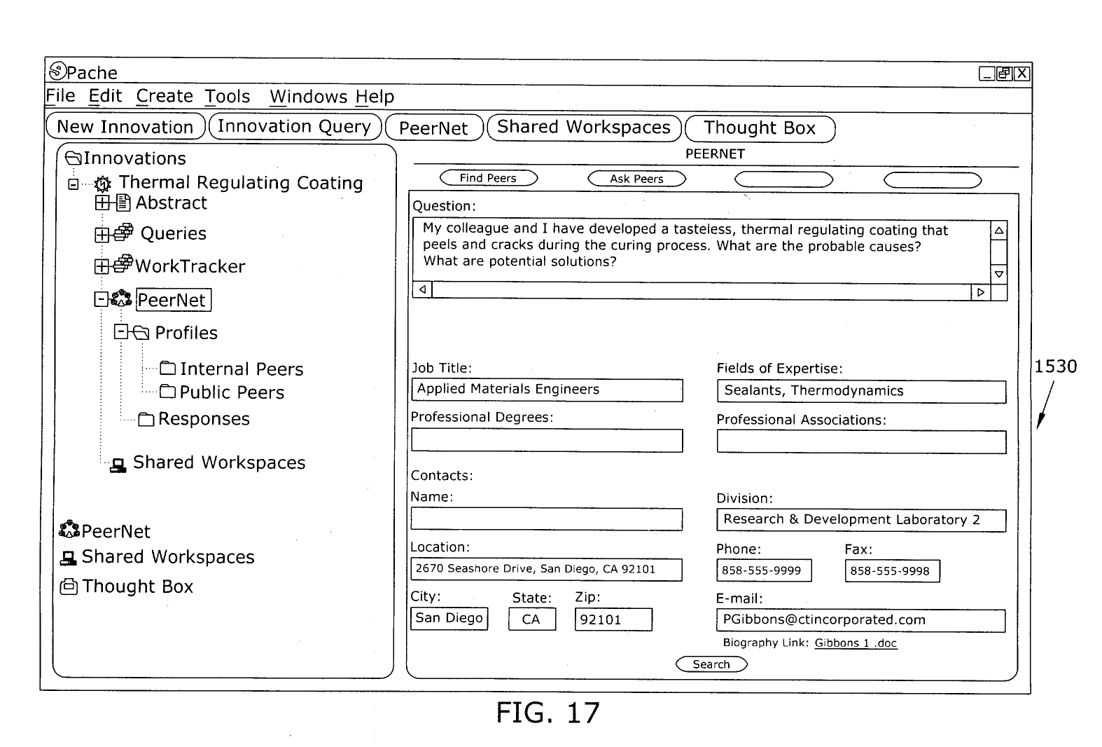

In an “ask peers” page 1530, exemplified in FIG. 17, the PeerNet 1500 allows a user to ask questions of his or her peers by entering search criteria for identifying the peers to whom the question(s) is (are) to be posed, and a question 1550 into the page 1530. The question 1550 is automatically e-mailed to all matching entries in the database. The user can search for people based on job title 1552, fields of expertise 1554, professional degrees 1556, professional associations 1558, name 1560, division 1562 or location 1564.

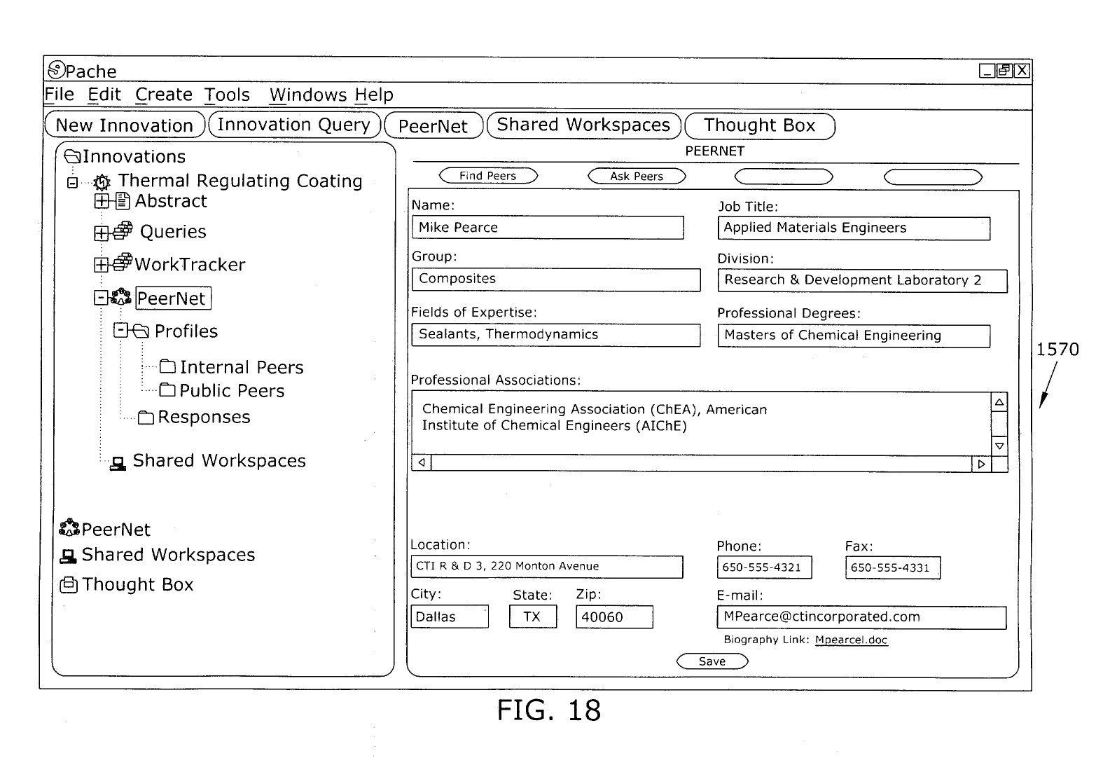

Similarly, the PeerNet 1500 allows the user to search for peers with specific qualifications with the “find peers” page 1540, as shown in FIG. 18. The “find peers” page 1540 allows the same criteria to be searched, but rather than automatically e-mailing a question to all matching entries, the “find peers” page 1540 displays a list of matching entries so that the user may view more detailed information on a particular person and then e-mail or call someone directly.

Both the “ask peers” page 1530 and the “find peers” page 1540 allow the user to decide between searching internally, externally or searching both at the same time. When responses are received from people contacted through the PeerNet 1500, the responses are stored in a subfolder for responses 1510, as shown in FIG. 16.

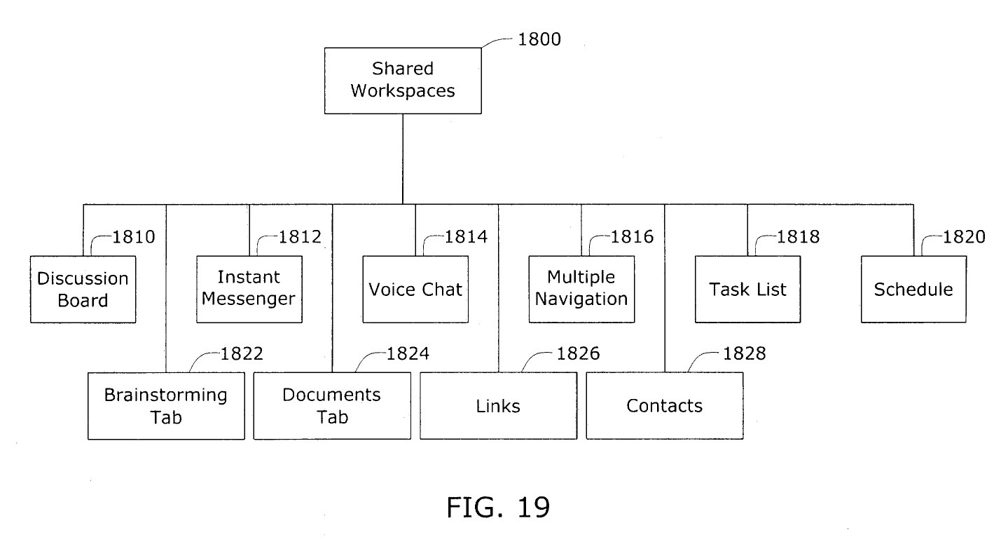

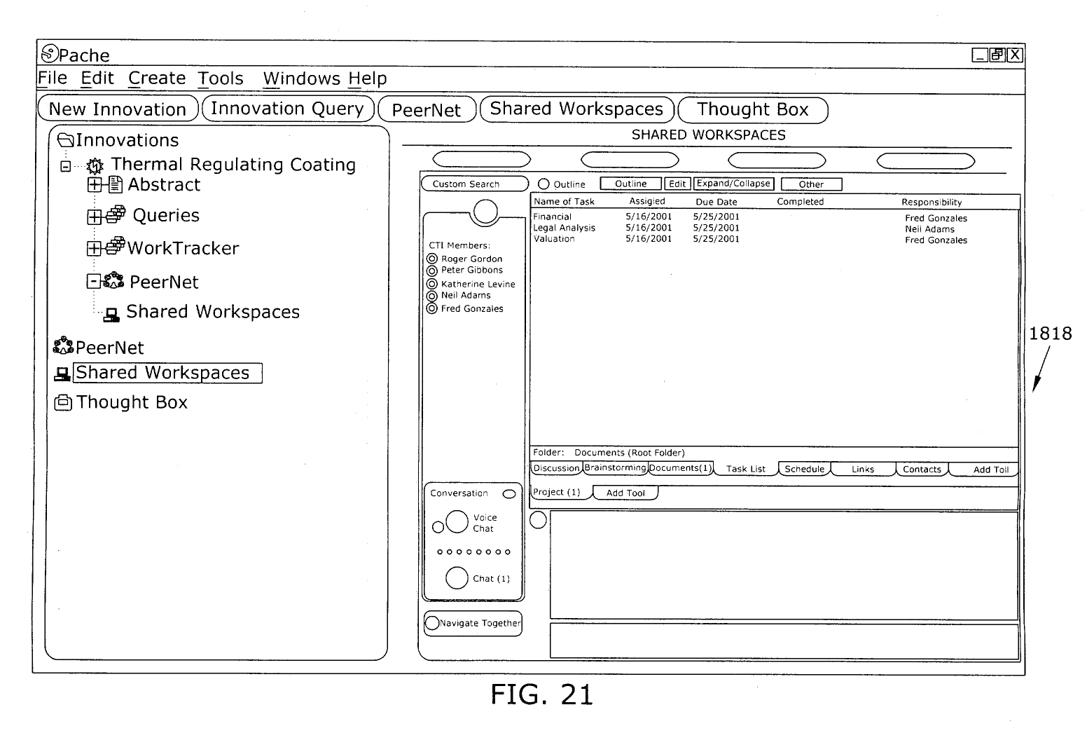

Once peers have been found using the PeerNet 1500, various users can collaborate on a project using a shared workspace 1800, as illustrated in FIGS. 19-22. There are many different ways in which the shared workspace 1800 alleviates problems resulting form collaborating between people in different places. First, people can communicate using a discussion board 1810, an instant messenger 1812 and voice chat feature 1814. The discussion board 1810 allows the people collaborating on a project to post text that everyone else collaborating on the project can read and respond to at their leisure; the instant messenger 1812 allows two or more people to have a real-time text based conversation over the network; and the voice chat feature 1814 allows people to speak with each other through their respective PC's 11, 14, 31 or 34 without using the phone system. Another feature that facilitates collaboration is the multiple navigation tool 1816, which allows one member of the team to navigate the internet while the others view what he or she is seeing.

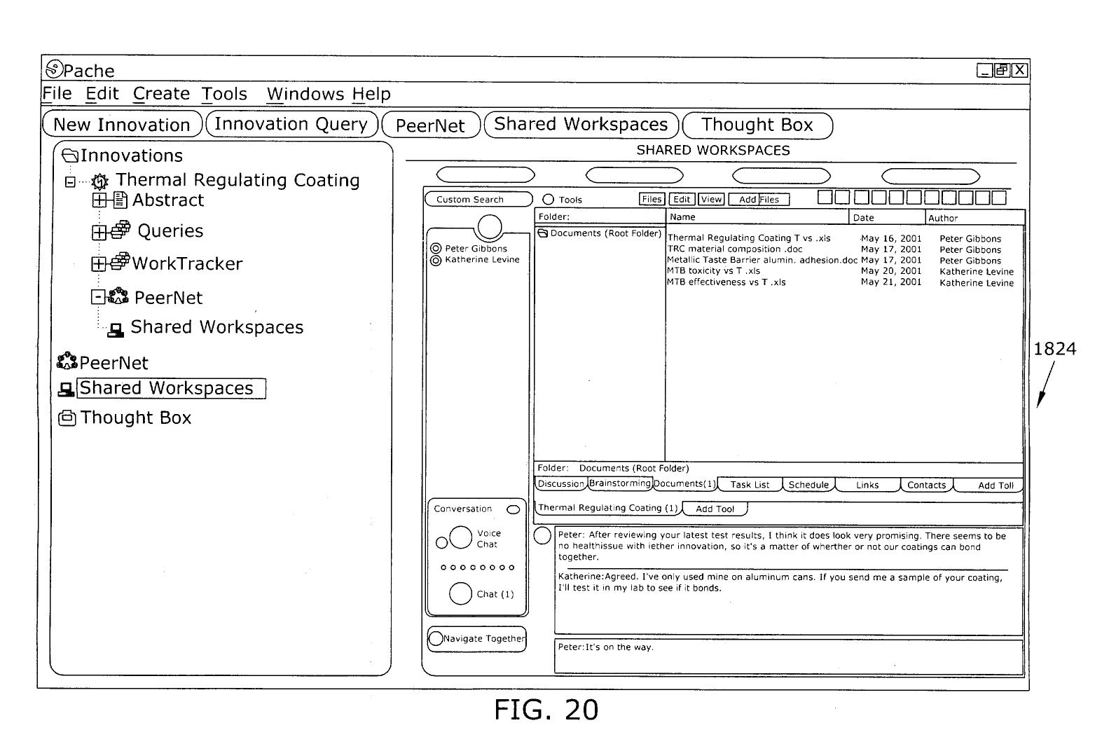

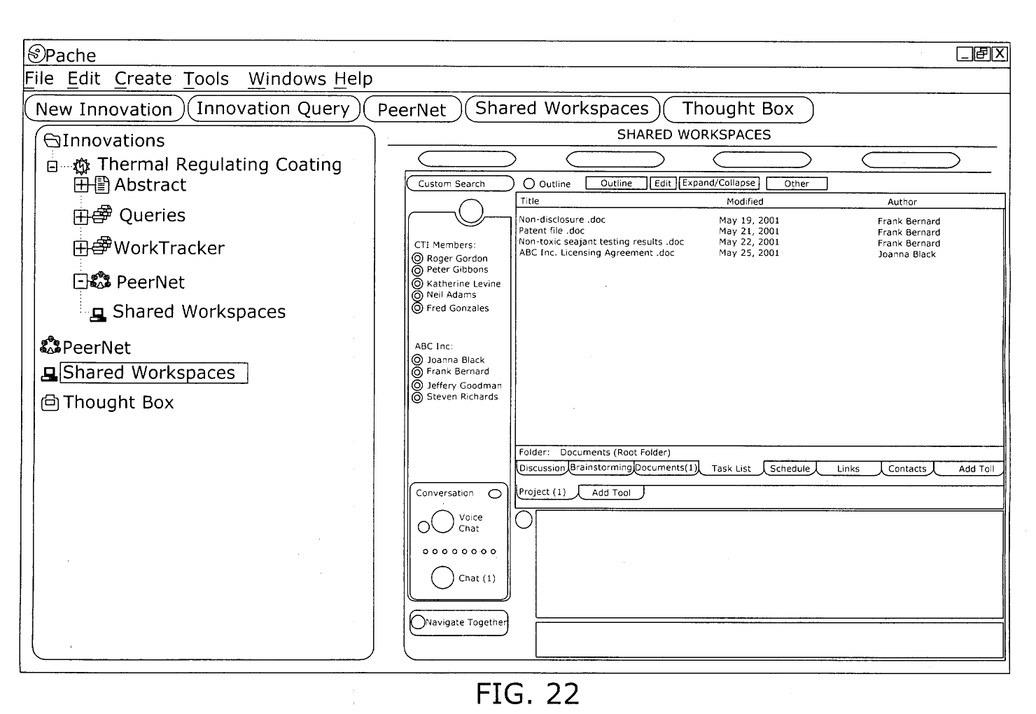

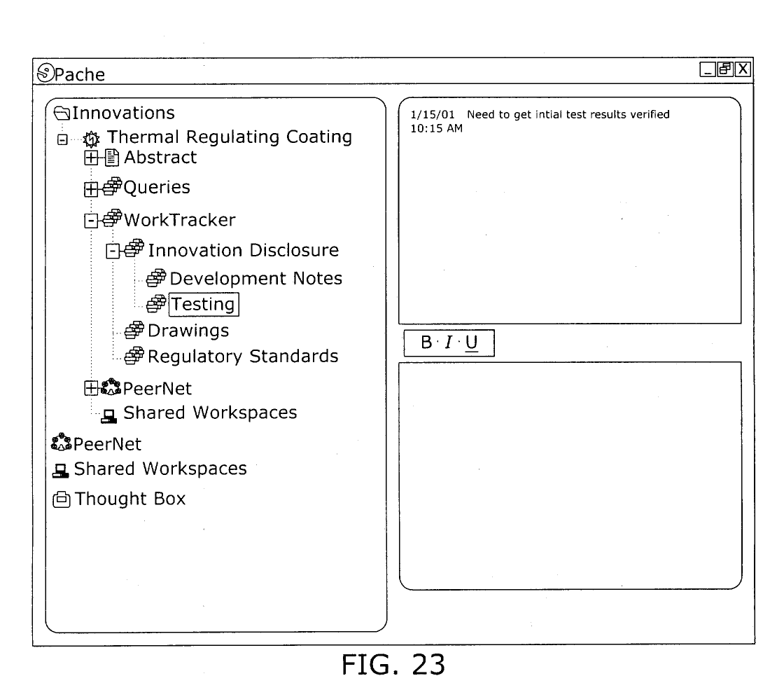

The remaining features of the shared workspace 1800 focus less on real time interaction between the collaborators, and more on enabling people in various locations to plan the progress of a project and share information in an organized and efficient manner. The task list 1818, as exemplified in FIGS. 22 and 23, allows anyone involved in a project to view what tasks are assigned to whom and the status of each task at a glance. Also, tasks can be assigned and modified using the task list 1818. The schedule 1820 allows people to see both a prospective schedule of tasks, expected completion dates and whether completed tasks were completed on schedule or behind schedule. In addition, the project manager can quickly and easily assign tasks to people in a variety of locations. The brainstorming tab 1822 provides a forum for discussing technical ideas relating to a project. This is especially helpful when the people involved in a project are in time zones that do not have overlapping work hours. The documents tab 1824, as shown in FIG. 20, provides a repository for documents related to a project. Each member of a project can post documents that other member might want to see, and can view any documents that the other members have posted at this location. The links tab 1826 allows the users to post links that are pertinent to the project. Finally, the contacts tab 1828 allows the users to keep track of contact information for other people collaborating on the project.

The shared workspace 1800 can be accessed directly from the main page 40 of the system (FIG. 3) or through a shared workspaces access link 620 in each innovation subfolder 610 (FIG. 6). When a user accesses the shared workspace 1800 either through the main page 40 or an innovation subfolder 610, links or tabs to each of the real time interaction tools and planning and information sharing tools discussed above are displayed, as can be seen in FIGS. 20-22.

Another feature of the present invention which is accessible through the main page 40, inter alia, as seen in FIG. 3, is the ThoughtBox 2200, which provides an easy way of maintaining notes. When the thoughtbox 2200 link is selected, a window is opened in which the user may store notes or view previously stored notes for for a subfolder or information within a specific innovation 610, as well as for a directory tree for all of that user's innovations. Unlike the previously described features of the innovation query page 1200, the PeerNet 1500, the shared workspaces 1800, etc., the ThoughtBox 2200, as shown in FIG. 23, is not accessible from within the innovations folder 600. The part of an innovation that the user is currently viewing affects where the ThoughtBox 2200 stores information.For example, if the user selects the ThoughtBox 2200 while viewing the task list 1818 for innovation 1 610, a window will appear displaying the user's previous notes for the task list 1818 for innovation 1. The user can then add a note to the ThoughtBox 2200 for the task list 1818 displayed on the screen, add a note to the ThotughtBox 2200 after selecting a different part of the directory for innovation 1 610 or any other innovation to which the user has access or close the ThoughtBox 2200. If there are three users collaborating on a project, each will be able to view the notes that the others store in the ThoughtBox 2200.

The above invention provides a system and method for documenting, tracking and facilitating development of intellectual capital. While the invention has been described with reference to exemplary embodiments various additions, deletions, substitutions, or other modifications may be made without departing from the spirit or scope of the invention. Accordingly, the invention is not to be considered as limited by the foregoing description, but is only limited by the scope of the appended claims.

What is claimed as new and desired to be protected by Letters Patent of the United States is:

1. A method for documenting, tracking and facilitating the development of intellectual capital comprising the steps of:
storing a plurality of intellectual capital database entries respectively on a plurality of computer stations;
entering search criteria into a user interface at one of the computer stations;
transmitting said search criteria and a level of access to said plurality of computer stations;
searching the plurality of intellectual capital database entries respectively stored at each of said plurality of computer stations for matching entries;
transmitting portions of said matching entries at or below said level of access to said computer station at which the search criteria is entered; and
displaying said portions of said matching entries in said user interface at said computer station entering the search criteria.

2. The method as in claim 1, further comprising the steps of:
selecting one of said matching entries; and
displaying said selected matching entry in its entirety.

3. The method as in claim 1, further comprising the steps of:
selecting one of said matching entries;
verifying said level of access prior to displaying said matching entry in its entirety;
displaying said selected matching entry in part or in its entirety in accordance with said level of access such that said level of access is equal to or greater to a level of access necessary to view said entire entry; and
displaying contact information for an appropriate person to contact for access to the entire entry if said level of access is less than the level of access necessary to view said selected matching entry in its entirety.

4. A method of documenting and tracking intellectual property comprising the steps of:
creating a plurality of intellectual capital entries on a computer system;
entering search criteria into a user interface;
transmitting said search criteria to said computer system;
searching said plurality of intellectual capital entries based on said search criteria to thereby obtain at least one matching entry;
transmitting a portion of each matching entry to said user interface; and
displaying said portion of each matching entry in said user interface.

5. The method as in claim 4, further comprising the steps of:
selecting one of said matching entries;
transmitting a request for additional information on said selected entry to said computer system;
transmitting the remainder of said selected entry to said user interface if a predetermined level of access required to view said entry enables public access thereto;
transmitting contact information for an appropriate person to contact for additional information about said selected matching entry to said user interface; and
displaying at least one of said selected entry or said contact information in said user interface.

6. A method of documenting and tracking intellectual capital comprising the steps of:
creating a plurality of intellectual capital database entries on a computer system;
entering search criteria on one of a plurality of computer stations;
transmitting said search criteria from said one of the plurality of computer stations to said computer system;
searching said plurality of intellectual capital database entries for entries matching said search criteria;
transmitting portions of said matching entries to said one of the plurality of computer stations; and
displaying said portions of said matching entries on said one of the plurality of computer stations.

7. The method as in claim 6, further comprising the steps of:
selecting one of said matching entries on said one of the plurality of computer stations;
transmitting a request for the remainder of said selected matching entry to said computer system;
transmitting the remainder of said matching entry to said one of the plurality of computer stations if a level of access required to view said selected matching entry enables public access thereto;
transmitting contact information for an appropriate person to contact to obtain the remainder of said selected matching entry; and
displaying the said remainder of said selected matching entry or said contact information on said one of the plurality of computer stations.

8. A computer system for documenting and tracking intellectual capital comprising:
a plurality of computer stations; and
a user interface on each of said plurality of computer stations;
wherein an intellectual capital database entry can be entered in said user interface and stored on the computer station at which the entry is entered;
wherein when search criteria are entered into said user interface by a user, said search criteria and a level of access assigned to said user are transmitted to each of said plurality of computer stations, each of said plurality of computer stations searches for matching intellectual capital database entries and transmits each matching entry at or below the level of access of the user entering the search criteria.

9. A computer system for documenting and tracking intellectual capital comprising:
a computer system; and
a user interface;
wherein a plurality of intellectual capital database entries can be entered in said user interface and stored on said computer system;
wherein when search criteria are received in the computer system for executing a query, said computer system searches each intellectual capital database entry stored on said computer system and transmits any matching entries at or below a predetermined level of access of the query.

10. A computer system for documenting, tracking, and facilitating the development of intellectual capital comprising:
a computer network including a plurality of computer stations, on which a plurality of innovation entries may be individually stored on a respective one of the plurality of computer stations; and
a user interface accessible through each of the plurality of computer stations, wherein the user interface provides access to a plurality of features including
a new innovation folder for each user having access to the network,
an innovation subfolder for at least one innovation stored within the new innovation folder, and
an innovation query page for enabling a user to search the plurality of innovation entries stored on each of the plurality of computer stations according to specified search criteria.

11. The system according to claim 10, wherein each innovation subfolder provides storage for a plurality of types of searchable abstracts for the corresponding innovation.

12. The system according to claim 11, wherein the plurality of types of abstracts for each innovation include a scientific and/or technical abstract, a business strategy abstract, a financial abstract, and a legal abstract.

13. The system according to claim 10, wherein the innovation query page enables a user to search among innovation entries stored both within computer stations in an internal network and computer stations in an external network, wherein the system restricts portions of search results which can be viewed by a user executing the search for search results returned from computer stations in the external network.

14. The system according to claim 10, wherein the system restricts portions of search results which can be viewed by a user executing a search through the innovation query page in accordance with an access level assigned to the user.

15. The system according to claim 10, further comprising a peer network for enabling users to locate, store and categorize electronic profiles of professionals with desired expertise related to a specified innovation.

16. The system according to claim 15, wherein the peer network is accessible from at least both a main page of the user interface and from each innovation subfolder.

17. The system according to claim 10, further comprising a shared workspace feature including tools for real time interaction on collaborative projects and planning and organizational tools for coordinating collaborative work on the projects.

18. The system according to claim 17, wherein the shared workspace is accessible from at least both a main page of the user interface and from each innovation subfolder.

19. The system according to claim 10, further comprising a component which enables a user to maintain notes linked with relevant files and features entered into and accessed in the system through the user interface.
